(19) United States
(12) Patent Application Publication
(10) Pub. No.: US 2023/0365160 A1
(43) Pub. Date: Nov. 16, 2023

(54) VEHICLE CONTROL APPARATUS AND VEHICLE CONTROL METHOD

(71) Applicant: Mitsubishi Electric Corporation, Tokyo (JP)

(72) Inventors: Michihiro OGATA, Tokyo (JP); Tomoki UNO, Tokyo (JP); Kazuo HITOSUGI, Tokyo (JP)

(73) Assignee: Mitsubishi Electric Corporation, Tokyo (JP)

(21) Appl. No.: 18/176,825

(22) Filed: Mar. 1, 2023

(30) Foreign Application Priority Data
May 12, 2022 (JP) 2022-078590

(51) Int. Cl. B60W 60/00; B60W 40/06

(52) U.S. Cl. CPC B60W 60/0013; B60W 40/06; B60W 2552/15; B60W 2552/30; B60W 2555/60; B60W 2556/20; B60W 2556/40

(57) ABSTRACT

To provide a vehicle control apparatus and a vehicle control method which can suppress that vehicle control is performed using a slope which may be wrong, when there is a possibility that the acquired road slope is wrong. A vehicle control apparatus estimates a traveling state slope based on the traveling state, calculates a map slope which is a slope of the road which includes front of the ego vehicle from map information, calculates the slope for control based on the traveling state slope and the map slope, determines whether or not accuracy of the map slope is low, does not use the map slope in calculation of the slope for control when determining that the accuracy of the map slope is low, and calculates the target value of vehicle control amount of the ego vehicle based on the traveling state and the slope for control.

### INCORPORATION BY REFERENCE

The disclosure of Japanese Patent Application No. 2022-78590 filed on May 12, 2022 including its specification, claims and drawings, is incorporated herein by reference in its entirety.

### BACKGROUND

This present disclosure is related with a vehicle control apparatus and a vehicle control method.

Recently, the automatic driving technology of vehicle is energetically developed for the purpose of improvement in safety and comfortability. In the road, there are the lateral slope for drainage of rain water, the lateral slope for reducing the acceleration in the lateral direction in the curve with large curvature, and the longitudinal slope or the lateral slope which are caused by the geographical reason. When there is a slope, the method of estimating the magnitude of slope and the method of using the slope information obtained from the outside for vehicle control are proposed, for controlling the vehicle appropriately during automatic driving or during steering by driver.

### SUMMARY

In the technology of JP 5257923 B, by calculating the proper vehicle speed in the curve according to the magnitude of slope using the slope information in the front of the ego vehicle, the feeling of safety of the driver at the time of curve entrance is improved. However, in this technology, although the vehicle control is performed using the slope information in the front of the ego vehicle, it is not determined whether or not the slope information in the front of the ego vehicle is correct, and when the slope information is wrong, the error occurs in the vehicle control, and uncomfortable feeling is given to the driver.

In the technology of the JP 2011-232128 A, when the receiving sensitivity of GPS is the predetermined level or more and a change of altitude is detected, the road slope is detected using data of altitude and the like. However, in this technology, although it is monitored by the receiving sensitivity of GPS, the accuracy of the altitude data itself is not determined. And, when the altitude data is wrong, the vehicle control is performed based on the wrong slope information, and uncomfortable feeling is given to the driver.

Then, the purpose of the present disclosure is to provide a vehicle control apparatus and a vehicle control method which can suppress that vehicle control is performed using a slope which may be wrong, when there is a possibility that the acquired road slope is wrong.

A vehicle control apparatus according to the present disclosure, including:
a traveling state acquisition unit that acquires a traveling state of an ego vehicle;
a road information acquisition unit that acquires map information of a road where the ego vehicle is traveling;
a slope calculation unit that estimates a traveling state slope which is a slope of the road at an ego vehicle position, based on the traveling state, calculates a map slope which is a slope of the road which includes a front of the ego vehicle, from the map information, and calculates a slope for control, based on the traveling state slope and the map slope; and
a vehicle control amount calculation unit that calculates a target value of vehicle control amount of the ego vehicle, based on the traveling state and the slope for the control,
wherein the slope calculation unit determines whether or not accuracy of the map slope is low, and does not use the map slope in calculation of the slope for control when determining that the accuracy of the map slope is low.

A vehicle control method according to the present disclosure, including:
a traveling state acquisition step of acquiring a traveling state of an ego vehicle;
a road information acquisition step of acquiring map information of a road where the ego vehicle is traveling;
a slope calculation step of estimating a traveling state slope which is a slope of the road at an ego vehicle position, based on the traveling state, calculating a map slope which is a slope of the road which includes a front of the ego vehicle, from the map information, and calculating a slope for control, based on the traveling state slope and the map slope; and
a vehicle control amount calculation step of calculating a target value of vehicle control amount of the ego vehicle, based on the traveling state and the slope for the control;
wherein in the slope calculation step, determining whether or not accuracy of the map slope is low, and not using the map slope in calculation of the slope for control when determining that the accuracy of the map slope is low.

According to the vehicle control apparatus and the vehicle control method of the present disclosure, the traveling state slope which is a slope of the road at the ego vehicle position is estimated based on the traveling state; the map slope which is a slope of the road which includes the front of the ego vehicle is calculated from the map information; and the slope for control is calculated based on the traveling state slope and the map slope. The target value of vehicle control amount of the ego vehicle is calculated based on the traveling state of the ego vehicle, and the slope for control. Accordingly, since the vehicle control is performed based on the slope of road, the accuracy of the vehicle control can be improved. Then, whether or not the accuracy of the map slope is low is determined, the map slope is not used in the calculation of the slope for control, when determining that the accuracy of the map slope is low. Accordingly, when there is a possibility that the map slope is wrong, the vehicle control can be suppressed from being performed using the map slope which may be wrong, and the accuracy of the vehicle control can be suppressed from being deteriorated.

### BRIEF DESCRIPTION OF THE DRAWINGS

FIG. 1 is a schematic configuration diagram of the vehicle system and the vehicle control apparatus according to Embodiment 1;

FIG. 2 is a schematic block diagram of the vehicle system and the vehicle control apparatus according to Embodiment 1;

FIG. 3 is a schematic hardware configuration diagram of the vehicle control apparatus according to Embodiment 1;

FIG. 4 is a schematic hardware configuration figure of the another example of the vehicle control apparatus according to Embodiment 1;

FIG. 5 is a figure for explaining calculation of the traveling state longitudinal slope according to Embodiment 1;

FIG. 6 is a figure for explaining calculation of the traveling state lateral slope according to Embodiment 1;

FIG. 7 is a figure for explaining calculation of the map slope according to Embodiment 1;

FIG. 8 is a figure for explaining the state equation according to Embodiment 1; and

FIG. 9 is a flowchart for explaining processing of the vehicle control apparatus according to Embodiment 1.

### DETAILED DESCRIPTION OF THE EMBODIMENTS

### 1. Embodiment 1

A vehicle system 1 and a vehicle control apparatus 50 according to Embodiment 1 will be explained with reference to drawings. In the present embodiment, the vehicle system 1 and the vehicle control apparatus 50 are mounted in the ego vehicle.

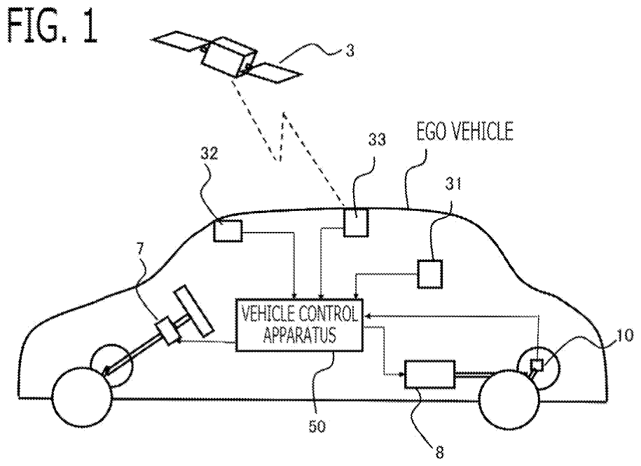

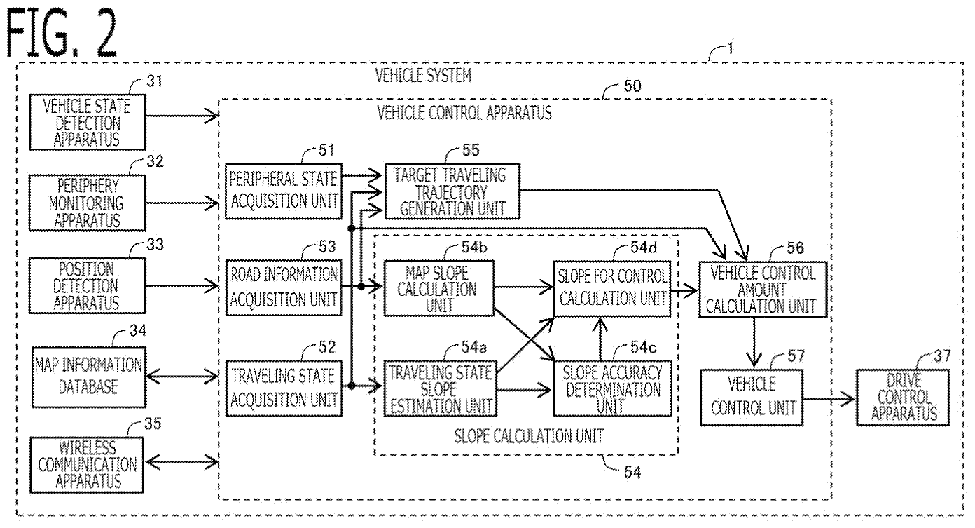

As shown in FIG. 1 and FIG. 2, the vehicle system 1 is provided with a vehicle state detection apparatus 31, a periphery monitoring apparatus 32, a position detection apparatus 33, a map information database 34, a wireless communication apparatus 35, a vehicle control apparatus 50, a drive control apparatus 37, and the like.

The vehicle state detection apparatus 31 is a detection apparatus which detects a traveling state of the ego vehicle. As the traveling state of the ego vehicle, a vehicle speed of the ego vehicle V, a roll angle speed, a pitch angle speed, and a yaw angle speed γ of the ego vehicle, an acceleration in the longitudinal direction αx, an acceleration in the vertical direction αz, and an acceleration αy in the lateral direction are detected. For example, as the vehicle state detection apparatus 31, a three axes angular velocity sensor which detects the roll angle speed, the pitch angle speed, and the yaw angle speed which are acted on the ego vehicle, a three axes acceleration sensor which detects the acceleration in the longitudinal direction, the acceleration in the vertical direction, and the acceleration in the lateral direction, and the speed sensor 10 which detects the rotational speed of the wheels are provided.

The periphery monitoring apparatus 32 is an apparatus which monitors the periphery of the vehicle, such as a camera and a radar. As the radar, a millimeter wave radar, a laser radar, an ultrasonic radar, and the like are used. The wireless communication device 35 performs a wireless communication with a base station, using the wireless communication standard of cellular communication system, such as 4G and 5G.

The position detection apparatus 33 is an apparatus which detects the current position (latitude, longitude, altitude) of the ego vehicle, and a GPS antenna which receives the signal outputted from satellites, such as GNSS (Global Navigation Satellite System), is used. Normally, although signals of a plurality of satellites are used, it is simplified only to one satellite 3 in FIG. 1. For detection of the current position of the ego vehicle, various kinds of methods, such as the method using the traveling lane identification number of the ego vehicle, the map matching method, the dead reckoning method, and the method using the detection information around the ego vehicle, may be used.

In the map information database 34, road information, such as a road shape (for example, a road position, a lane number, a shape of each lane, a road type, a regulation speed, and the like), a road slope of a longitudinal slope and a lateral slope of each point of road (hereinafter, referred to as a map longitudinal slope, a map lateral slope, and a map slope), a sign, and a signal is stored. In the map information database 34, a position (latitude, longitude, altitude) of each point is also stored. The map information database 34 is mainly constituted of a storage apparatus. The map information database 34 may be provided in a server outside the vehicle connected to the network, and the vehicle control apparatus 50 may acquire required road information from the server outside the vehicle via the wireless communication apparatus 35.

As the drive control apparatus 37, a power controller, a brake controller, an automatic steering controller, a light controller, and the like are provided. The power controller controls output of a power machine 8, such as an internal combustion engine and a motor. The brake controller controls brake operation of an electric brake apparatus. The automatic steering controller controls an electric steering apparatus 7. The light controller controls a direction indicator, a hazard lamp, and the like.

### 1-1. Vehicle Control Apparatus 50

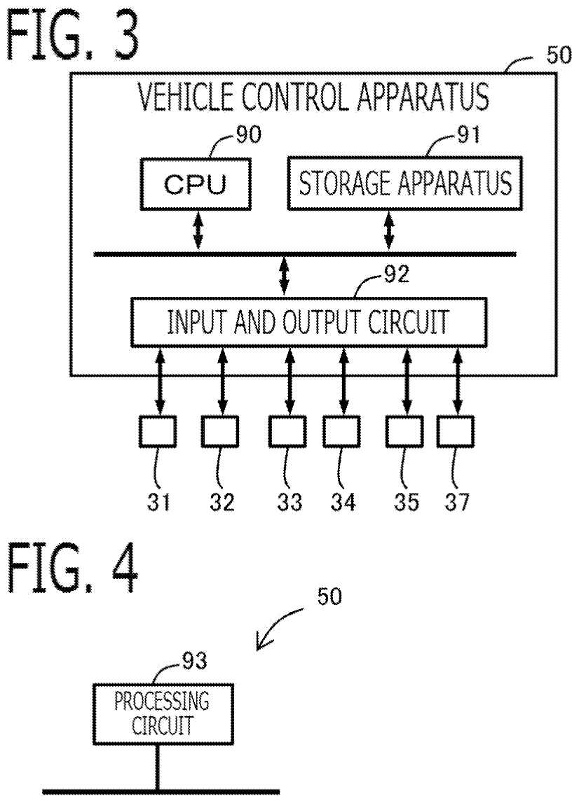

The vehicle control apparatus 50 is provided with functional units such as a peripheral state acquisition unit 51, a traveling state acquisition unit 52, a road information acquisition unit 53, a slope calculation unit 54, a target traveling trajectory generation unit 55, a vehicle control amount calculation unit 56, a vehicle control unit 57, and the like. Each function of the vehicle control apparatus 50 is realized by processing circuits provided in the vehicle control apparatus 50. As shown in FIG. 3, specifically, the vehicle control apparatus 50 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), a hard disk, and a DVD apparatus, are used.

The input and output circuit 92 is provided with a communication device, an A/D converter, an input/output port, a driving circuit, and the like. The input and output circuit 92 is connected to the vehicle state detection apparatus 31, the periphery monitoring apparatus 32, the position detection apparatus 33, the map information database 34, the wireless communication apparatus 35, and the drive control apparatus 37, and communicates with these devices.

Then, the arithmetic processor 90 runs software items (programs) stored in the storage apparatus 91 and collaborates with other hardware devices in the vehicle control apparatus 50, such as the storage apparatus 91, and the input and output circuit 92, so that the respective functions of the functional units 51 to 57 provided in the vehicle control apparatus 50 are realized. Setting data items such as a determination value to be utilized in the functional units 51 to 57 are stored, as part of software items (programs), in the storage apparatus 91 such as a ROM.

Alternatively, as shown in FIG. 4, the vehicle control apparatus 50 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the vehicle control apparatus 50 will be described in detail below.

### 1-1-1. Peripheral State Acquisition Unit 51

The peripheral state acquisition unit 51 acquires a peripheral state of the ego vehicle. For example, the peripheral state acquisition unit 51 detects the other vehicle and the like which exist around the ego vehicle. The peripheral state acquisition unit 51 detects a position, a traveling direction, a traveling speed, and the like of the ego vehicle, based on the detection information acquired from the periphery monitoring apparatus 32, and the position information on the ego vehicle acquired from the periphery monitoring apparatus 32. The peripheral state acquisition unit 51 detects an obstacle, a pedestrian, a road sign, and the like other than the other vehicle.

### 1-1-2. Traveling State Acquisition Unit 52

The traveling state acquisition unit 52 acquires the traveling state of the ego vehicle. The traveling state acquisition unit 52 acquires a vehicle speed V of the ego vehicle, a roll angle speed, a pitch angle speed, and a yaw angle speed γ of the ego vehicle, an acceleration in the longitudinal direction αx, an acceleration in the vertical direction αz, and an acceleration in the lateral direction αy from the vehicle state detection apparatus 31, as the traveling state of the ego vehicle. The traveling state acquisition unit 52 acquires the position of the ego vehicle, the traveling direction, and the like, based on the position information on the ego vehicle acquired from the position detection apparatus 33. The traveling state acquisition unit 52 acquires the information on the traveling position of the ego vehicle with respect to the lane, based on the shape of the lane acquired from the peripheral state acquisition unit 51. The traveling state acquisition unit 52 acquires a driving operation state, such as the steering angle, an output of the power machine, such as the internal combustion engine, and an operating state of the brake, from the vehicle control unit 57.

### 1-1-3. Road Information Acquisition Unit 53

The road information acquisition unit 53 acquires the map information of the road where the ego vehicle is traveling. The road information acquisition unit 53 acquires the map information of the road where the ego vehicle is traveling, from the map information database 34, based on the position information on the ego vehicle acquired from the position detection apparatus 33. Herein, the road where the ego vehicle is traveling is a road corresponding to the target traveling trajectory described below. In the present embodiment, the road information acquisition unit 53 acquires the road shape of the road where the ego vehicle is traveling (for example, the road position (latitude, longitude, altitude), the lane number, the shape of each lane, the road type, the regulation speed, and the like), and the slope (the map slope) of the longitudinal slope (the map longitudinal slope) and the lateral slope (the map lateral slope) of each point of the road where the ego vehicle is traveling, from the map information database 34.

The road information acquisition unit 53 acquires the road information around the ego vehicle which is detected by the peripheral state acquisition unit 51. For example, the road information acquisition unit 53 detects a shape of a lane marking and the like of road, based on the detection information on the lane marking, such as a white line and a road shoulder, acquired from the periphery monitoring apparatus 32; and detects the shape and the number of the lane, and the like, based on the detected shape of the lane marking and the like of road. For example, the lane marking of road is expressed by a plural-order polynomial (for example, third-order).

### 1-1-4. Slope Calculation Unit 54

The slope calculation unit 54 is provided with a traveling state slope estimation unit 54a, a map slope calculation unit 54b, a slope accuracy determination unit 54c, and a slope for control calculation unit 54d.

### Traveling State Slope Estimation Unit 54a

The traveling state slope estimation unit 54a estimates a traveling state slope which is a slope of the road at the ego vehicle position, based on the traveling state acquired by the traveling state acquisition unit 52. In the present embodiment, the traveling state slope estimation unit 54a estimates a traveling state longitudinal slope Slopeest which is a longitudinal slope, and a traveling state lateral slope Cantest which is a lateral slope of the road at the ego vehicle position, based on the traveling state.

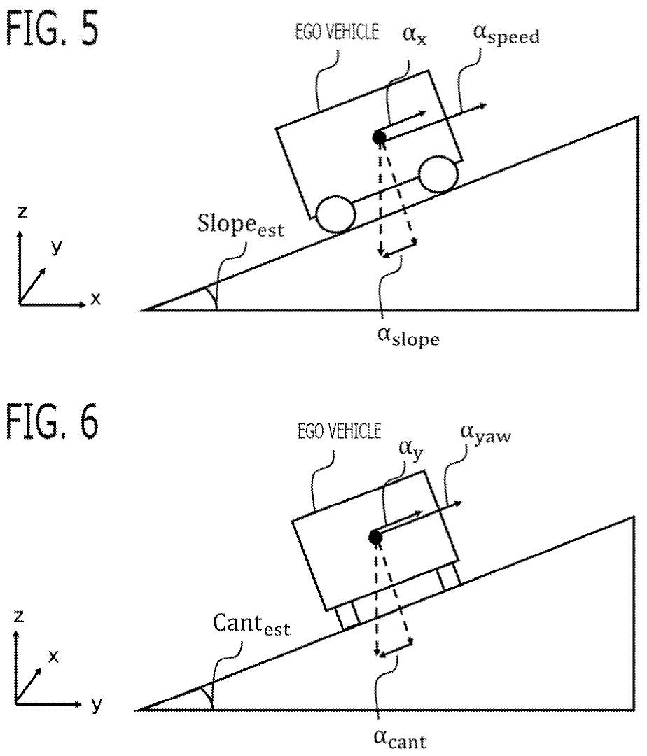

As shown in the schematic diagram of FIG. 5, and the next equation, an acceleration in the longitudinal direction αx which acts on the ego vehicle includes two components of a longitudinal acceleration αspeed by motion of the ego vehicle, and a longitudinal acceleration αslope which acts on the ego vehicle by the longitudinal slope of road. As shown in the next equation, the traveling state slope estimation unit 54a calculates the longitudinal acceleration αspeed by the vehicle motion, based on a time change speed of the vehicle speed V acquired by the traveling state acquisition unit 52. Then, the traveling state slope estimation unit 54a estimates the traveling state longitudinal slope Slopeest which is a longitudinal slope of road at the ego vehicle position, based on a value obtained by subtracting a vehicle motion longitudinal acceleration αx which acts on the ego vehicle acquired by the traveling state acquisition unit 52, from the longitudinal acceleration αspeed. The longitudinal slope is an inclination angle of the longitudinal direction of the road surface with respect to the horizontal plane. Herein, g is a gravitational acceleration. Other well-known methods may be used for estimation of the traveling state longitudinal slope Slopeest.

$$\begin{matrix}[ Equation 1 ] & \\ \begin{matrix}{α}_{x} = {α}_{speed} - {α}_{slope} \\ {α}_{speed} = \frac{dV}{dt} \\ {α}_{slope} = g \cdot sin ( {Slope}_{e s t} ) \\ {Slope}_{e s t} = {sin}^{- 1} ( \frac{\frac{d V}{d t} - {α}_{x}}{g} )\end{matrix} & ( 1 )\end{matrix}$$

As shown in the schematic diagram of FIG. 6, and the next equation, the acceleration in the lateral direction αy which acts on the ego vehicle includes two components of a lateral acceleration αyaw by the turning movement of the ego vehicle, and a lateral acceleration αcant which acts on the ego vehicle by the lateral slope of road. As shown in the next equation, the traveling state slope estimation unit 54a calculates the lateral acceleration αyaw by the turning movement, by multiplying the vehicle speed V to the yaw angle speed γ acquired by the traveling state acquisition unit 52. Then, the traveling state slope estimation unit 54a estimates the traveling state lateral slope Cantest which is a lateral slope of the road at the ego vehicle position, based on a value obtained by subtracting the lateral acceleration αy which acts on the ego vehicle acquired by the traveling state acquisition unit 52, from the lateral acceleration αyaw by the turning movement. The lateral slope is an inclination angle of the lateral direction of the road surface with respect to the horizontal plane. Other well-known methods may be used for estimation of the traveling state lateral slope Cantest.

$$\begin{matrix}[ Equation 2 ] & \\ \begin{matrix}{α}_{y} = {α}_{y a w} - {α}_{c a n t} \\ {α}_{y a w} = γ \cdot V \\ {α}_{c a n t} = g \cdot sin ( {Cant}_{e s t} ) \\ Can {t}_{e s t} = {sin}^{- 1} ( \frac{γ \cdot V - {α}_{y}}{g} )\end{matrix} & ( 2 )\end{matrix}$$

### Map Slope Calculation Unit 54b

The map slope calculation unit 54b calculates the map slope which is a slope of the road which includes the front of the ego vehicle from the map information acquired by the road information acquisition unit 53. In the present embodiment, the map slope calculation unit 54b calculates the map longitudinal slope Slopemap which is a longitudinal slope and the map lateral slope Cantmap which is a lateral slope of road which includes the front of the ego vehicle, from the map information. The map slope calculation unit 54b calculates the map composite slope Synthemap obtained by combining the map longitudinal slope and the map lateral slope.

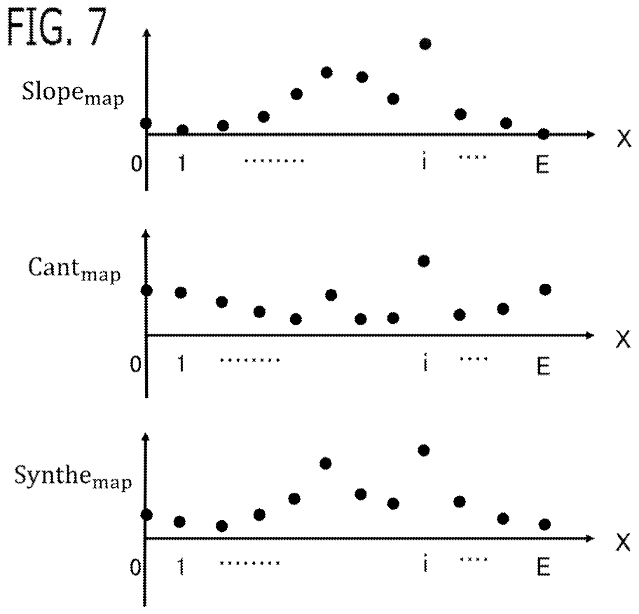

FIG. 7 shows a calculation example of the map slope. The map slope calculation unit 54b calculates the map longitudinal slope Slopemap(i) and the map lateral slope Cantmap(i) at each point i (i=0, 1, . . . , E-1, E) for every constant interval from the ego vehicle position to a certain E point in the front of the ego vehicle. The map slope calculation unit 54b calculates the map composite slope Synthemap(i) at each point i, based on the map longitudinal slope Slopemap(i) and the map lateral slope Cantmap(i) at each point i, using the next equation.

[Equation 3]

Syntheₘₐₚ(i)=\sqrt{Slopeₘₐₚ(i)²+Cantₘₐₚ(i)²} (3)

### Slope Accuracy Determination Unit 54c

The slope accuracy determination unit 54c determines whether or not the accuracy of the map slope is low. In the present embodiment, the slope accuracy determination unit 54c determines whether or not the accuracy of the map longitudinal slope Slopemap is low, and determines whether or not the accuracy of the map lateral slope Cantmap is low.

### Determination of Accuracy of Map Longitudinal Slope in Front of Ego Vehicle

The slope accuracy determination unit 54c determines whether or not the accuracy of the map longitudinal slope in the front of the ego vehicle is low, based on one or both of an absolute value and a change amount of the map longitudinal slope Slopemap in the front of the ego vehicle.

The slope accuracy determination unit 54c determines that the accuracy of the map longitudinal slope in the front of the ego vehicle is low, when the absolute value of the map longitudinal slope Slopemap(i) at any one point i from the ego vehicle position to the front E point exceeds an absolute value threshold value for longitudinal.

The slope accuracy determination unit 54c calculates a change amount between the map longitudinal slope Slopemap(i) at each point i, and the map longitudinal slope Slopemap(i+m) at point i+m which is separated by a prescribed interval from each point i, about each point i from the ego vehicle position to the front E point; and determines that the accuracy of the map longitudinal slope in the front of the ego vehicle is low, when the absolute value of the change amount at any one point i exceeds a change amount threshold value for longitudinal.

The absolute value threshold value for longitudinal and the change amount threshold value for longitudinal are set based on the design standard value of the longitudinal slope prescribed by law, such as Road Construction Ordinance.

The slope accuracy determination unit 54c calculates an altitude longitudinal slope estimation value Slopealt which is a longitudinal slope in the front of the ego vehicle, based on the altitude of the road in the front of the ego vehicle included in the map information. The slope accuracy determination unit 54c determines whether or not the accuracy of the map longitudinal slope in the front of the ego vehicle is low, based on the map longitudinal slope Slopemap in the front of the ego vehicle, and the altitude longitudinal slope estimation value Slopealt. For example, the slope accuracy determination unit 54c calculates the altitude longitudinal slope estimation value Slopealt(i) at each point i, based on a deviation between the altitude Alti(i) at each point i, and the altitude Alti at point i+m which is separated by a prescribed interval (i+m) from each point i, about each point i from the ego vehicle position to the front E point. Then, the slope accuracy determination unit 54c calculates an absolute value of the deviation between the map longitudinal slope Slopemap(i) and the altitude longitudinal slope estimation value Slopealt(i), about each point i; and determines that the accuracy of the map longitudinal slope in the front of the ego vehicle is low, when the absolute value of the deviation at any one point i exceeds a deviation threshold value for longitudinal.

The slope accuracy determination unit 54c determines that the accuracy of the map longitudinal slope in the front of the ego vehicle is low, when determining that the accuracy of the map longitudinal slope in the front of the ego vehicle is low in either one of the determination of the absolute value of the map longitudinal slope, the determination of the change amount of the map longitudinal slope, and the comparison determination with the altitude longitudinal slope estimation value. On the other hand, the slope accuracy determination unit 54c determines that the accuracy of the map longitudinal slope in the front of the ego vehicle is not low (high) about these determinations, when not determining that the accuracy of the map longitudinal slope in the front of the ego vehicle is low in either one of the determination of the absolute value of the map longitudinal slope, the determination of the change amount of the map longitudinal slope, and the comparison determination with the altitude longitudinal slope estimation value.

All of the determination of the absolute value of the map longitudinal slope, the determination of the change amount of the map longitudinal slope, and the comparison determination with the altitude longitudinal slope estimation value may not be executed. Any one or more of the determination of the absolute value of the map longitudinal slope, the determination of the change amount of the map longitudinal slope, and the comparison determination with the altitude longitudinal slope estimation value may be executed.

### Determination of Accuracy of Map Lateral Slope in Front of Ego Vehicle

The slope accuracy determination unit 54c determines whether or not the accuracy of the map lateral slope in the front of the ego vehicle is low, based on one or both of the absolute value and the change amount of the map lateral slope Cantmap in the front of the ego vehicle.

The slope accuracy determination unit 54c determines that the accuracy of the map lateral slope in the front of the ego vehicle is low, when the absolute value of the map lateral slope Cantmap(i) at any one point i from the ego vehicle position to the front E point exceeds an absolute value threshold value for lateral.

The slope accuracy determination unit 54c calculates a change amount between the map lateral slope Cantmap(i) at each point i, and the map lateral slope Cantmap(i+m) at point i+m which is separated by a prescribed interval from each point i, about each point i from the ego vehicle position to the front E point; and determines that the accuracy of the map lateral slope in the front of the ego vehicle is low, when the absolute value of the change amount at any one point i exceeds a change amount threshold value for lateral.

The absolute value threshold value for lateral and the change amount threshold value for lateral are set based on the design standard value of the lateral slope prescribed by law, such as Road Construction Ordinance.

The slope accuracy determination unit 54c calculates a curvature lateral slope estimation value Cantcury which is a lateral slope in the front of the ego vehicle, based on the curvature Cury of the road in the front of the ego vehicle included in the map information, and the regulation speed of road Vmax in the front of the ego vehicle. The slope accuracy determination unit 54c determines whether or not the accuracy of the map lateral slope in the front of the ego vehicle is low, based on the map lateral slope Cantmap in the front of the ego vehicle, and the curvature lateral slope estimation value Cantcury in the front of the ego vehicle. For example, by referring to data for curvature lateral slope estimation in which a relation between the curvature Curv, the regulation speed Vmax, and the curvature lateral slope estimation value Cantcury is preliminarily set, the slope accuracy determination unit 54c calculates the curvature lateral slope estimation value Cantcurv(i) at each point i corresponding to the curvature Curv(i) and the regulation speed Vmax(i) at each point i, about each point i from the ego vehicle position to the front E point. The data for curvature lateral slope estimation is preliminarily set based on the design standard value of the road prescribed by law, such as Road Construction Ordinance. Then, the slope accuracy determination unit 54c calculates an absolute value of a deviation between the map lateral slope Cantmap(i) and the curvature lateral slope estimation value Cantcurv(i), about each point i; and determines that the accuracy of the map lateral slope in the front of the ego vehicle is low, when the absolute value of the deviation at any one point i exceeds a deviation threshold value for lateral.

The slope accuracy determination unit 54c determines that the accuracy of the map lateral slope in the front of the ego vehicle is low, when determining that the accuracy of the map lateral slope in the front of the ego vehicle is low in either one of the determination of the absolute value of the map lateral slope, the determination of the change amount of the map lateral slope, and the comparison determination with the curvature lateral slope estimation value. On the other hand, the slope accuracy determination unit 54c determines that the accuracy of the map lateral slope in the front of the ego vehicle is not low (high) in these determinations, when not determining that the accuracy of the map lateral slope in the front of the ego vehicle is low in either one of the determination of the absolute value of the map lateral slope, the determination of the change amount of the map lateral slope, and the comparison determination with the curvature lateral slope estimation value.

All of the determination of the absolute value of the map lateral slope, the determination of the change amount of the map lateral slope, and the comparison determination with the curvature lateral slope estimation value may not be executed. Any one or more of the determination of the absolute value of the map lateral slope, the determination of the change amount of the map lateral slope, and the comparison determination with the curvature lateral slope estimation value may be executed.

### Two-Step Determination of Accuracy

The slope accuracy determination unit 54c may determine that the accuracy of the map longitudinal slope in the front of the ego vehicle is low, when determining that the accuracy of the map longitudinal slope in the front of the ego vehicle is lower than a first state for longitudinal, and is higher than a second state for longitudinal whose accuracy is lower that of the first state for longitudinal. And, the slope accuracy determination unit 54c may determine that both of the accuracy of the map longitudinal slope in the front of the ego vehicle and the accuracy of the map lateral slope in the front of the ego vehicle are low, when determining that the accuracy of the map longitudinal slope in the front of the ego vehicle is lower than the second state for longitudinal. For example, the slope accuracy determination unit 54c determines that the accuracy of the map longitudinal slope in the front of the ego vehicle is low, when the absolute value of the map longitudinal slope Slopemap(i) in the front of the ego vehicle at any one point i exceeds a first absolute value threshold value for longitudinal corresponding to the first state for longitudinal, but does not exceed a second absolute value threshold value for longitudinal corresponding to the second state for longitudinal. The second absolute value threshold value for longitudinal is set to a value larger than the first absolute value threshold value for longitudinal. On the other hand, the slope accuracy determination unit 54c determines that both of the accuracy of the map longitudinal slope in the front of the ego vehicle and the accuracy of the map lateral slope in the front of the ego vehicle are low, when the absolute value of the map longitudinal slope Slopemap(i) in the front of the ego vehicle at anyone point i exceeds the second absolute value threshold value for longitudinal. Also about the determination of the change amount of the map longitudinal slope Slopemap in the front of the ego vehicle, and the comparison determination with the altitude longitudinal slope estimation value, two threshold values are set similarly and these are determined in two steps.

The slope accuracy determination unit 54c may determine that the accuracy of the map lateral slope in the front of the ego vehicle is low, when determining that the accuracy of the map lateral slope in the front of the ego vehicle is lower than a first state for lateral, and is higher than a second state for lateral whose accuracy is lower than the first state for lateral. And, the slope accuracy determination unit 54c may determine that both of the accuracy of the map longitudinal slope in the front of the ego vehicle and the accuracy of the map lateral slope in the front of the ego vehicle are low, when determining that the accuracy of the map lateral slope in the front of the ego vehicle is lower than the second state for lateral. For example, the slope accuracy determination unit 54c determines that the accuracy of the map lateral slope in the front of the ego vehicle is low, when the absolute value of map lateral slope Cantmap(i) in the front of the ego vehicle at any one point i exceeds a first absolute value threshold value for lateral corresponding to the first state for lateral, but does not exceed a second absolute value threshold value for lateral corresponding to the second state for lateral. The second absolute value threshold value for lateral is set to a value larger than the first absolute value threshold value for lateral. On the other hand, the slope accuracy determination unit 54c determines that both of the accuracy of the map longitudinal slope in the front of the ego vehicle and the accuracy of the map lateral slope in the front of the ego vehicle are low, when the absolute value of the map lateral slope Cantmap(i) in the front of the ego vehicle at any one point i exceeds the second threshold value for lateral. Also about the determination of the change amount of the map lateral slope in the front of the ego vehicle, and the comparison determination with the curvature lateral slope estimation value, two threshold values are set similarly and these are determined in two steps.

### Determination of Accuracy by Map Composite Slope

The slope accuracy determination unit 54c determines whether or not the accuracy of the map slope is low, based on the map composite slope Synthemap. About each point i from the ego vehicle position to the front E point, the slope accuracy determination unit 54c determines that both of the accuracy of the map longitudinal slope in the front of the ego vehicle and the accuracy of the map lateral slope in the front of the ego vehicle are low, when the absolute value of the map composite slope Synthemap(i) at any one point i exceeds an absolute value threshold value for composite. The absolute value threshold value for composite is set based on the design standard value of the longitudinal slope and the lateral slope prescribed by law, such as Road Construction Ordinance.

### Change of Threshold Value

The slope accuracy determination unit 54c may change the absolute value threshold value for longitudinal, the change amount threshold value for longitudinal, the absolute value threshold value for lateral, the change amount threshold value for lateral, and the absolute value threshold value for composite, according to the road type. Since the design standard value of slope is changed according to the road type, each threshold value may be changed according to the road type. As the road type, there are a highway, an ordinary road, a road in urban areas, a road in local areas, an agricultural road, a forest road, and the like. The slope accuracy determination unit 54c may change the absolute value threshold value for longitudinal, the change amount threshold value for longitudinal, the absolute value threshold value for lateral, the change amount threshold value for lateral, and the absolute value threshold value for composite, according to the regulation speed of road. Since the design standard value of slope is changed according to the regulation speed of road, each threshold value may be changed according to the regulation speed of road. For example, as the regulation speed becomes low, an allowable longitudinal slope becomes large, and the absolute value threshold value for longitudinal, the change amount threshold value for longitudinal, and the like are enlarged.

### Determination of Accuracy of Slope at Ego Vehicle Position

The slope accuracy determination unit 54c calculates a longitudinal slope difference which is a difference between the traveling state longitudinal slope Slopeest and the map longitudinal slope Slopemap(0) at the ego vehicle position; and determines whether or not the accuracy of the map longitudinal slope at the ego vehicle position is low, based on the longitudinal slope difference. The slope accuracy determination unit 54c determines that the accuracy of the map longitudinal slope at the ego vehicle position is low, when an absolute value of the longitudinal slope difference exceeds a slope difference threshold value for longitudinal.

The slope accuracy determination unit 54c calculates a lateral slope difference which is a difference between the traveling state lateral slope Cantest and the map lateral slope Cantmap(0) at the ego vehicle position; and determines whether or not the accuracy of the map lateral slope at the ego vehicle position is low, based on the lateral slope difference. The slope accuracy determination unit 54c determines that the accuracy of the map lateral slope at the ego vehicle position is low, when an absolute value of the lateral slope difference exceeds a slope difference threshold value for lateral.

### Slope for Control Calculation Unit 54d

The slope for control calculation unit 54d calculates a slope for control, based on the traveling state slope and the map slope. The slope for control calculation unit 54d does not use the map slope in the calculation of the slope for control, when determining that the accuracy of the map slope is low.

In the present embodiment, the slope for control calculation unit 54d calculates a longitudinal slope for control Slopecnt, based on the traveling state longitudinal slope Slopeest and the map longitudinal slope Slopemap, and calculates a lateral slope for control Cantcnt, based on the traveling state lateral slope Cantest and the map lateral slope Cantmap.

When not determining that the accuracy of the map longitudinal slope in the front of the ego vehicle and the accuracy of the map longitudinal slope at the ego vehicle position are low, the slope for control calculation unit 54d sets the longitudinal slope for control Slopecnt(i) at each point (i) from the ego vehicle position to the E point in the front of the ego vehicle, to the map longitudinal slope Slopemap(i) at each point i in the front of the ego vehicle and at the ego vehicle position.

When determining that the accuracy of the map longitudinal slope in the front of the ego vehicle is low and not determining that the accuracy of the map longitudinal slope at the ego vehicle position is low, the slope for control calculation unit 54d sets the longitudinal slope for control Slopecnt(i) at each point (i) from the ego vehicle position to the E point in the front of the ego vehicle, to the same traveling state longitudinal slope Slopeest or the same map longitudinal slope Slopemap(0) at the ego vehicle position. When determining that the accuracy of the map longitudinal slope in the front of the ego vehicle and the accuracy of the map longitudinal slope at the ego vehicle position are low, the slope for control calculation unit 54d sets the longitudinal slope for control Slopecnt(i) at each point (i) from the ego vehicle position to the E point in the front of the ego vehicle, to the same 0 or the same traveling state longitudinal slope Slopeest.

When not determining that the accuracy of the map lateral slope in the front of the ego vehicle and the accuracy of the map lateral slope at the ego vehicle position are low, the slope for control calculation unit 54d sets the lateral slope for control Cantcnt(i) at each point (i) from the ego vehicle position to the E point in the front of the ego vehicle, to the map lateral slope Cantmap(i) at each point i in the front of the ego vehicle and at the ego vehicle position.

When determining that the accuracy of the map lateral slope in the front of the ego vehicle is low and not determining that the accuracy of the map lateral slope at the ego vehicle position is low, the slope for control calculation unit 54d sets the lateral slope for control Cantcnt(i) at each point (i) from the ego vehicle position to the E point in the front of the ego vehicle, to the same traveling state lateral slope Cantest or the same map lateral slope Cantmap(0) at the ego vehicle position. When determining that the accuracy of the map lateral slope in the front of the ego vehicle and the accuracy of the map lateral slope at the ego vehicle position are low, the slope for control calculation unit 54d sets the lateral slope for control Cantcnt(i) at each point (i) from the ego vehicle position to the E point in the front of the ego vehicle, to the same 0 or the same traveling state lateral slope Cantest.

Besides these, as long as the map slope of a type whose accuracy is determined as low is not used for setting of the slope for control, the slope for control may be set by other setting methods.

### Switching Time

After determining that the accuracy of the map slope in the front of the ego vehicle becomes low, a time lag exists until the ego vehicle reaches at the front point which causes the accuracy deterioration. Accordingly, about each of the longitudinal slope and the lateral slope, after determining that the accuracy of the map slope in the front of the ego vehicle becomes low from the state determined that the accuracy of the map slope in the front of the ego vehicle is not low, the slope for control calculation unit 54d may gradually switch from the slope for control in the case where the accuracy is not low to the slope for control in the case where the accuracy is low. Accordingly, sudden change of the slope for control can be suppressed. On the other hand, when determining that the accuracy of the map slope at the ego vehicle position becomes low, a time lag does not exist. Accordingly, about each of the longitudinal slope and the lateral slope, after determining that the accuracy of the map slope at the ego vehicle position becomes low from the state determined that the accuracy of the map slope at the ego vehicle position is not low, the slope for control calculation unit 54d immediately switches from the slope for control in the case where the accuracy is not low to the slope for control in the case where the accuracy is low. That is, the slope for control calculation unit 54d makes the time for switching not to use the map slope in the calculation of the slope for control after determining that the accuracy of the map slope at the ego vehicle position becomes low shorter than the time for switching not to use the map slope in the calculation of the slope for control after determining that the accuracy of the map slope in the front of the ego vehicle becomes low.

### 1-1-5. Target Traveling Trajectory Generation Unit 55

The target traveling trajectory generation unit 55 generates a target traveling trajectory in accordance with state of the other vehicle, the obstacle, and the pedestrian around the ego vehicle detected by the peripheral state acquisition unit 51, and the road shape around the ego vehicle detected by the road information acquisition unit 53. The target traveling trajectory is a traveling plan of time series of the position of the ego vehicle, the traveling direction of the ego vehicle, the speed of the ego vehicle, and the like at each future time point. Various kinds of well-known methods are used for the generation of the target traveling trajectory.

### 1-1-6. Vehicle Control Amount Calculation Unit 56

The vehicle control amount calculation unit 56 calculates a target value of vehicle control amount of the ego vehicle, based on the traveling state of the ego vehicle, and the slope for control. In the present embodiment, as the slope for control, the longitudinal slope for control Slopecnt and the lateral slope for control Cantcnt are used. The vehicle control amount calculation unit 56 predicts a future vehicle behavior of the ego vehicle, based on the traveling state of the ego vehicle, and the slope for control; and calculates the target value of vehicle control amount of the ego vehicle, based on the prediction result.

In the present embodiment, using a state equation of a plurality of state variables which express a behavior of vehicle as a vehicle model, the vehicle control amount calculation unit 56 predicts the vehicle behavior of future time series of the ego vehicle, based on the traveling state of the ego vehicle, the slope for control, and the target value of vehicle control amount of future time series. Then, the vehicle control amount calculation unit 56 performs an optimal control which calculates the target value of vehicle control amount of future time series that a value of an evaluation function which evaluates desirability of the predicted vehicle behavior of future time series becomes the minimum (or the maximum). The state equation is a differential equation of each state variable. In the present embodiment, the target value of vehicle control amount is set to a target value of steering angle δ of the ego vehicle at each time point, and a target value of acceleration α in the longitudinal direction of the ego vehicle at each time point.

Since the future vehicle behavior is predicted considering the slope of road, the prediction accuracy of the vehicle behavior can be improved, and the vehicle control amount suitable for the slope can be calculated. Accordingly, on the road with a slope, the accuracy of vehicle control is improved, and the uncomfortable feeling to the driver can be reduced.

The vehicle control amount calculation unit 56 sets the longitudinal slope for control Slopecnt (k) at each time point k, based on the longitudinal slope for control Slopecnt(i) at each point i from the ego vehicle position to the E point in front of the ego vehicle. The vehicle control amount calculation unit 56 sets the lateral slope for control Cantcnt (k) at each time point k, based on the lateral slope for control Cantcnt(i) at each point i from the ego vehicle position to the E point in front of the ego vehicle.

### Vehicle Model

In the present embodiment, a two-wheel model is used for the vehicle model. As shown in the next equation, the state equation of the vehicle model can be expressed by a differential equation of each state variable expressing the behavior of vehicle. As the state equation of the vehicle model, various kinds of well-known state equations maybe used. But, it was changed so that a term which uses the lateral slope for control Cantcnt is included in the state equation of the lateral slip angle β, and a term which uses the longitudinal slope for control Slopecnt is included in the state equation of the speed V.

$$\begin{matrix}[ Equation 4 ] & \\ \begin{matrix}[ \begin{matrix}\dot{L} \\ \dot{W} \\ \dot{θ} \\ \dot{γ} \\ \dot{β} \\ \dot{V} \\ \dot{δ} \\ \dot{α}\end{matrix} ] = [ \begin{matrix}V cos ( θ + β ) \\ V sin ( θ + β ) \\ γ \\ \frac{2}{I} ( {L}_{f} {Y}_{f} - {L}_{r} {Y}_{r} ) \\ - γ + \frac{2 ( {Y}_{f} + {Y}_{r} )}{MV} + \frac{g \cdot sin ( {Cant}_{cnt} )}{V} \\ α - g \cdot sin ( {Slope}_{cnt} ) \\ ω \\ j\end{matrix} ] \\ {Y}_{f} = - {K}_{f} ( β + \frac{{L}_{f}}{V} γ - δ ) \\ {Y}_{r} = - {K}_{r} ( β + \frac{{L}_{r}}{V} γ )\end{matrix} & ( 4 )\end{matrix}$$

Herein, a dot sign of the upper part of each variable of the left side indicates a time differential value of each state variable. As the state variable, L shows a position of the ego vehicle in the longitudinal direction with respect to the position of the target traveling trajectory at each time point; W shows a position of the ego vehicle in the lateral direction with respect to the position of the target traveling trajectory at each time point; θ is an inclination of the longitudinal direction of the ego vehicle with respect to an extending direction of the target traveling trajectory at each time point; γ is a yaw angle speed of the ego vehicle at each time point; β is the lateral slip angle of the center of gravity of the ego vehicle at each time point; V is the speed of the ego vehicle at each time point; δ is the steering angle of wheel of the ego vehicle at each time point; and α is the acceleration of the ego vehicle in the longitudinal direction at each time point.

Cantcnt is the lateral slope for control of the road where the ego vehicle is located at each time point; Slopecnt is the longitudinal slope for control of the road where the ego vehicle is located at each time point; ω is the steering angle speed of the ego vehicle at each time point; and j is a jerk of the ego vehicle in the longitudinal direction at each time point. As the preliminarily set vehicle parameters, M is a mass of vehicle; g is a gravitational acceleration; Lf is a distance between the vehicle center of gravity and an axle of the front wheel; Lr is a distance between the vehicle center of gravity and an axle of the rear wheel; Yf is a cornering force of the front wheel; Yr is a cornering force of the rear wheel; Kf is a cornering stiffness of the front wheel tire; and Kr is a cornering stiffness of the rear wheel tire.

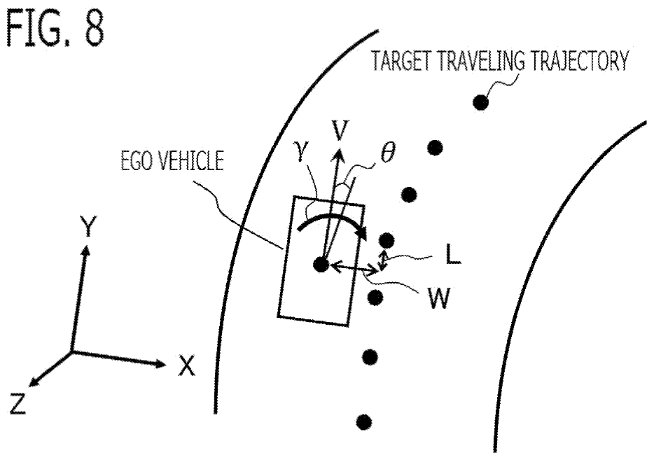

The state equation is expressed in the ego vehicle coordinate system X, Y, and Z. As shown in FIG. 8, X is the lateral direction of the ego vehicle, Y is the longitudinal direction of the ego vehicle, and Z is the vertical direction of the ego vehicle. Instead of the ego vehicle coordinate system, the coordinate system on the basis of the target traveling trajectory may be used.

As shown in the fifth row of the first equation of the equation (4), a term which uses the lateral slope for control Cantcnt is included in the state equation (the differential equation) of the lateral slip angle β. As shown in the sixth row of the first equation of the equation (4), a term which uses the longitudinal slope for control Slopecnt is included in the state equation (the differential equation) of the speed V. Accordingly, the behavior of the ego vehicle in which the lateral slope for control Cantcnt and the longitudinal slope for control Slopecnt are considered can be predicted, and the target value of vehicle control amount can be calculated based on the prediction result.

### Evaluation Function

In the present embodiment, the next equation is used as the evaluation function J which evaluates the desirability of the predicted vehicle behavior. One which was deformed from the equation (5) may be used as the evaluation function J.

$$\begin{matrix}[ Equation 5 ] & \\ \begin{matrix}J = {( {y}_{N} - y r e {f}_{N} )}^{T} P ( {y}_{N} - {yref}_{N} ) + {\sum }_{k = 1}^{N - 1} ( {( {y}_{k} - y r e {f}_{k} )}^{T} Q ( {y}_{k} - y r e {f}_{k} ) + {u}_{k}^{T} R {u}_{k} ) \\ {y}_{k} = [ {W}_{k} , {L}_{k} , {θ}_{k} + {β}_{k} , {V}_{k} , {α}_{k} ] \\ {u}_{k} = [ {j}_{k} , {ω}_{k} ] \\ {yref}_{k} = [ 0 , 0 , 0 , {Vref}_{k} , α {ref}_{k} ]\end{matrix} & ( 5 )\end{matrix}$$

Herein, k (k=0, 1, . . . , N-1, N) is a time point number which expresses each time point of current and future. k=0 is current and k=N expresses the final prediction time point. The time point number k is increased one by one from 0 to N at every time interval Δstep. Accordingly, k×ΔTstep is an elapsed time of each time point k from current. yk is a vector of the output variables of the state equation at each time point k. uk is a vector of the input variables of the state equation at each time point k. yrefk is a target value of the vector of the output variables at each time point k, and values in the state where the ego vehicle coincides with the target traveling trajectory at each time point is set. P is a weight to a deviation from the target values of output variables at the final prediction time point (k=N). Q is a weight to a deviation from the target values of output variables at the future each time point (k=1, . . . , N-1) except the final prediction time point. A deviation of the traveling state of the vehicle from the target traveling trajectory at each time point is evaluated by terms of these weights P and Q. R is a weight to a deviation from the target values of input variables at the future each time point (k=1, . . . , N-1) except the final prediction time point. By the term of this weight R, the jerk j and the steering angle speed ω of the ego vehicle are evaluated so as not to become large too much. Accordingly, variation of the steering angle and variation of the vehicle acceleration, and a following property to the target traveling trajectory are balanced by setting of each weight P, Q, and R, and the vehicle control with few uncomfortable feelings for the driver is performed.

The vehicle control amount calculation unit 56 solves the optimization problem, and calculates the optimum values of the state variables and the input variables at each time point k. Specifically, using the state equation of the equation (4), from the initial value of each state variable at the current time point (k=0), the vehicle control amount calculation unit 56 calculates the state variables at future each time point (k=1, . . . , N), based on the set input variables at each time point, the target traveling trajectory at each time point k, and the longitudinal slope for control and the lateral slope for control at each time point k. Then, the vehicle control amount calculation unit 56 calculates the value of the evaluation function J, based on the state variables and the input variables at each time point k which were calculated, and changes the input variables at each time point k so that the value of the evaluation function J decreases. Various kinds of well-known methods are used for this change. After that, the vehicle control amount calculation unit 56 calculates the state variables at each time point k again using the changed input variables at each time point k, the state equation of the equation (4), and the like; calculates the value of the evaluation function J; and changes the input variables at each time point so that the value of the evaluation function J may decrease. Until the value of the evaluation function J becomes sufficient small, and it is determined that the optimization problem was solved, the change of the input variables is continued.

The target value of the vehicle control amount at each time point k is set based on the optimum value of the state variables and the input variables at each time point k after the optimization problem was solved. In the present embodiment, the target value of vehicle control amount at each time point k is set to the steering angle δk at each time point k and the acceleration αk in the longitudinal direction which are included in the optimum values of the state variables at each time point k.

### 1-1-7. Vehicle Control Unit 57

The vehicle control unit 57 controls the vehicle, based on the target value of vehicle control amount. In the present embodiment, the target value of vehicle control amount is the target value of steering angle δ at each time point, and the target value of acceleration α in the longitudinal direction at each time point.

The vehicle control unit 57 calculates a command value to the power controller, a command value to the brake controller, and a command value to the automatic steering controller, based on the target value of steering angle δ at each time point, and the acceleration α in the longitudinal direction at each time point; and transmits to each apparatus.

The power controller controls output of the power machine, such as the internal combustion engine and the motor, according to the command value. The brake controller controls brake operation of the electric brake apparatus, according to the command value. The automatic steering controller controls the electric steering apparatus, according to the command value.

### 1-1-8. Flowchart

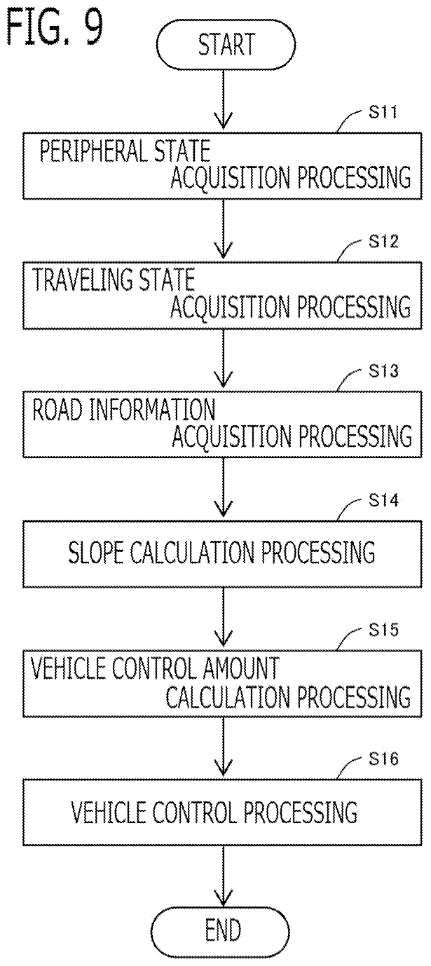

The processing explained above can be configured like the flowchart shown in FIG. 9. Processing of FIG. 9 is executed at every predetermined calculation period, for example.

In the step S11, as mentioned above, the peripheral state acquisition unit 51 executes a peripheral state acquisition processing (a peripheral state acquisition step) that acquires the peripheral state of the ego vehicle. In the step S12, as mentioned above, the traveling state acquisition unit 52 executes a traveling state acquisition processing (a traveling state acquisition step) that acquires the traveling state of the ego vehicle. In the step S13, as mentioned above, the road information acquisition unit 53 executes a road information acquisition processing (a road information acquisition step) that acquires the map information of the road where the ego vehicle is traveling.

In the step S14, as mentioned above, the slope calculation unit 54 executes a slope calculation processing (a slope calculation step) that estimates the traveling state slope which is a slope of the road at the ego vehicle position, based on the traveling state; calculates the map slope which is a slope of the road which includes the front of the ego vehicle, from the map information; and calculates the slope for control, based on the traveling state slope and the map slope. As mentioned above, the slope calculation unit 54 determines whether or not the accuracy of the map slope is low; and does not use the map slope in the calculation of the slope for control, when determining that the accuracy of the map slope is low. In the present embodiment, as mentioned above, the longitudinal slope and the lateral slope are calculated, the accuracy is determined about each, and the longitudinal slope for control and the lateral slope for control are calculated.

In the step S15, as mentioned above, the vehicle control amount calculation unit 56 executes a vehicle control amount calculation processing (a vehicle control amount calculation step) that calculates the target value of vehicle control amount of the ego vehicle, based on the traveling state of the ego vehicle, and the slope for control.

In the step S16, as mentioned above, the vehicle control unit 57 executes a vehicle control processing (a vehicle control step) that controls the vehicle, based on the target value of vehicle control amount.

### Other Embodiments

In the above-mentioned embodiments, there was explained the case where both of the longitudinal slope and the lateral slope are calculated as the slope. However, one of the longitudinal slope and the lateral slope may be calculated as the slope. That is, if only the longitudinal slope is calculated as the slope, the slope calculation unit 54 estimates the traveling state longitudinal slope, calculates the map longitudinal slope, calculates the longitudinal slope for control based on the traveling state longitudinal slope and the map longitudinal slope, determines whether or not the accuracy of the map longitudinal slope is low, and does not use the map longitudinal slope in the calculation of the longitudinal slope for control, when determining that the accuracy of the map longitudinal slope is low. The vehicle control amount calculation unit 56 calculates the target value of vehicle control amount of the ego vehicle, based on the traveling state of the ego vehicle, and the longitudinal slope for control. On the other hand, if only the lateral slope is calculated as the slope, the slope calculation unit 54 estimates the traveling state lateral slope, calculates the map lateral slope, calculates the lateral slope for control based on the traveling state lateral slope and the map lateral slope, determines whether or not the accuracy of the map lateral slope is low, and does not use the map lateral slope in the calculation of the lateral slope for control, when determining that the accuracy of the map lateral slope is low. The vehicle control amount calculation unit 56 calculates a target value of vehicle control amount of the ego vehicle, based on the traveling state of the ego vehicle, and the lateral slope for control.

### Summary of Aspects of the Present Disclosure

Hereinafter, the aspects of the present disclosure is summarized as appendices.

### Appendix 1

A vehicle control apparatus comprising:
a traveling state acquisition unit that acquires a traveling state of an ego vehicle;
a road information acquisition unit that acquires map information of a road where the ego vehicle is traveling;
a slope calculation unit that estimates a traveling state slope which is a slope of the road at an ego vehicle position, based on the traveling state, calculates a map slope which is a slope of the road which includes a front of the ego vehicle, from the map information, and calculates a slope for control, based on the traveling state slope and the map slope; and
a vehicle control amount calculation unit that calculates a target value of vehicle control amount of the ego vehicle, based on the traveling state and the slope for the control,
wherein the slope calculation unit determines whether or not accuracy of the map slope is low, and does not use the map slope in calculation of the slope for control when determining that the accuracy of the map slope is low.

### Appendix 2

The vehicle control apparatus according to Appendix 1,
wherein the slope calculation unit estimates a traveling state lateral slope which is a lateral slope and a traveling state longitudinal slope which is a longitudinal slope, of the road at the ego vehicle position, based on the traveling state;
calculates a map lateral slope which is a lateral slope and a map longitudinal slope which is a longitudinal slope, of the road including the front of the ego vehicle, from the map information;
calculates a longitudinal slope for control, based on the traveling state longitudinal slope and the map longitudinal slope; and
calculates a lateral slope for control, based on the traveling state lateral slope and the map lateral slope, and
wherein the vehicle control amount calculation unit calculates the target value of vehicle control amount of the ego vehicle, based on the traveling state, the longitudinal slope for control, and the lateral slope for control.

### Appendix 3

The vehicle control apparatus according to Appendix 2,
wherein the slope calculation unit determines whether or not the accuracy of the map longitudinal slope in the front of the ego vehicle is low, based on one or both of an absolute value and a change amount of the map longitudinal slope in the front of the ego vehicle;
determines whether or not the accuracy of the map lateral slope in the front of the ego vehicle is low, based on one or both of an absolute value and a change amount of the map lateral slope in the front of the ego vehicle;
does not use the map longitudinal slope in the front of the ego vehicle in calculation of the longitudinal slope for control, when determining that the accuracy of the map longitudinal slope in the front of the ego vehicle is low; and
does not use the map lateral slope in the front of the ego vehicle in calculation of the lateral slope for control, when determining that the accuracy of the map lateral slope in the front of the ego vehicle is low.

### Appendix 4

The vehicle control apparatus according to Appendix 2 or 3,
wherein the slope calculation unit calculates a curvature lateral slope estimation value which is a lateral slope in the front of the ego vehicle, based on a curvature of the road in the front of the ego vehicle and a regulation speed of the road in the front of the ego vehicle which are included in the map information;
determines whether or not the accuracy of the map lateral slope in the front of the ego vehicle is low, based on the map lateral slope in the front of the ego vehicle, and the curvature lateral slope estimation value in the front of the ego vehicle; and
does not use the map lateral slope in the front of the ego vehicle in calculation of the lateral slope for control when determining that the accuracy of the map lateral slope in the front of the ego vehicle is low.

### Appendix 5

The vehicle control apparatus according to anyone of Appendices 2 to 4,
wherein the slope calculation unit calculates an altitude longitudinal slope estimation value which is a longitudinal slope in the front of the ego vehicle, based on an altitude of the road in the front of the ego vehicle included in the map information;
determines whether or not the accuracy of the map longitudinal slope in the front of the ego vehicle is low, based on the map longitudinal slope in the front of the ego vehicle, and the altitude longitudinal slope estimation value in the front of the ego vehicle; and
does not use the map longitudinal slope in the front of the ego vehicle in calculation of the longitudinal slope for control when determining that the accuracy of the map longitudinal slope in the front of the ego vehicle is low.

### Appendix 6

The vehicle control apparatus according to any one of Appendices 2 to 5,
wherein, when determining that the accuracy of the map longitudinal slope in the front of the ego vehicle is lower than a first state for longitudinal and is higher than a second state for longitudinal whose accuracy is lower that of the first state for longitudinal, the slope calculation unit determines that the accuracy of the map longitudinal slope in the front of the ego vehicle is low;
when determining that the accuracy of the map longitudinal slope in the front of the ego vehicle is lower than the second state for longitudinal, the slope calculation unit determines that both of the accuracy of the map longitudinal slope in the front of the ego vehicle and the accuracy of the map lateral slope in the front of the ego vehicle are low;
when determining that the accuracy of the map lateral slope in the front of the ego vehicle is lower than a first state for lateral and is higher than a second state for lateral whose accuracy is lower than that of the first state for lateral, the slope calculation unit determines that the accuracy of the map lateral slope in the front of the ego vehicle is low;
when determining that the accuracy of the map lateral slope in the front of the ego vehicle is lower than the second state for lateral, the slope calculation unit determines that both of the accuracy of the map longitudinal slope in the front of the ego vehicle and the accuracy of the map lateral slope in the front of the ego vehicle are low;
when determining that the accuracy of the map longitudinal slope in the front of the ego vehicle is low, the slope calculation unit does not use the map longitudinal slope in the front of the ego vehicle in calculation of the longitudinal slope for control; and
when determining that the accuracy of the map lateral slope in the front of the ego vehicle is low, the slope calculation unit does not use the map lateral slope in the front of the ego vehicle in calculation of the lateral slope for control.

### Appendix 7

The vehicle control apparatus according to anyone of Appendices 2 to 6,
wherein the slope calculation unit calculates a longitudinal slope difference which is a difference between the traveling state longitudinal slope and the map longitudinal slope at the ego vehicle position;
determines that whether or not the accuracy of the map longitudinal slope at the ego vehicle position is low, based on the longitudinal slope difference;
calculates a lateral slope difference which is a difference between the traveling state lateral slope and the map lateral slope at the ego vehicle position;
determines whether or not the accuracy of the map lateral slope at the ego vehicle position is low, based on the lateral slope difference;
does not use the map longitudinal slope at the ego vehicle position in calculation of the longitudinal slope for control, when determining that the accuracy of the map longitudinal slope at the ego vehicle position is low; and
does not use the map lateral slope at the ego vehicle position in calculation of the lateral slope for control, when determining that the accuracy of the map lateral slope at the ego vehicle position is low.

### Appendix 8

The vehicle control apparatus according to Appendix 2,
wherein the slope calculation unit calculates a map composite slope in the front of the ego vehicle which is obtained by combining the map longitudinal slope in the front of the ego vehicle and the map lateral slope in the front of the ego vehicle; and
determines whether or not the accuracy of the map slope in the front of the ego vehicle is low, based on the map composite slope in the front of the ego vehicle.

### Appendix 9

The vehicle control apparatus according to anyone of Appendices 1 to 8,
wherein the slope calculation unit changes a threshold value which is used when determining whether or not the accuracy of the map slope is low, according to a road type.

### Appendix 10

The vehicle control apparatus according to anyone of Appendices 1 to 9,
wherein the slope calculation unit changes a threshold value which is used when determining whether or not the accuracy of the map slope is low, according to a regulation speed of road.

### Appendix 11

The vehicle control apparatus according to anyone of Appendices 1 to 10,
wherein the slope calculation unit determines whether or not the accuracy of the map slope in the front of the ego vehicle is low;
determines whether or not the accuracy of the map slope at the ego vehicle position is low; and
makes a switching time until switching so as not to use the map slope in calculation of the slope for control after determining that the accuracy of the map slope in the front of the ego vehicle becomes low shorter than a switching time until switching so as not to use the map slope in calculation of the slope for control after determining that the accuracy of the map slope at the ego vehicle position becomes low.

### Appendix 12

A vehicle control method comprising:
a traveling state acquisition step of acquiring a traveling state of an ego vehicle;
a road information acquisition step of acquiring map information of a road where the ego vehicle is traveling;
a slope calculation step of estimating a traveling state slope which is a slope of the road at an ego vehicle position, based on the traveling state, calculating a map slope which is a slope of the road which includes a front of the ego vehicle, from the map information, and calculating a slope for control, based on the traveling state slope and the map slope; and
a vehicle control amount calculation step of calculating a target value of vehicle control amount of the ego vehicle, based on the traveling state and the slope for the control;
wherein in the slope calculation step, determining whether or not accuracy of the map slope is low, and not using the map slope in calculation of the slope for control when determining that the accuracy of the map slope is low.

Although the present disclosure is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present disclosure. For example, at least one of the constituent components maybe modified, added, or eliminated.

What is claimed is:

1. A vehicle control apparatus comprising at least one processor configured to implement:
a traveling state acquisitor that acquires a traveling state of an ego vehicle;
a road information acquisitor that acquires map information of a road where the ego vehicle is traveling;
a slope calculator that estimates a traveling state slope which is a slope of the road at an ego vehicle position, based on the traveling state, calculates a map slope which is a slope of the road which includes a front of the ego vehicle, from the map information, and calculates a slope for control, based on the traveling state slope and the map slope; and
a vehicle control amount calculator that calculates a target value of vehicle control amount of the ego vehicle, based on the traveling state and the slope for the control,
wherein the slope calculator determines whether or not accuracy of the map slope is low, and does not use the map slope in calculation of the slope for control when determining that the accuracy of the map slope is low.

2. The vehicle control apparatus according to claim 1,
wherein the slope calculator estimates a traveling state lateral slope which is a lateral slope and a traveling state longitudinal slope which is a longitudinal slope, of the road at the ego vehicle position, based on the traveling state;
calculates a map lateral slope which is a lateral slope and a map longitudinal slope which is a longitudinal slope, of the road including the front of the ego vehicle, from the map information;
calculates a longitudinal slope for control, based on the traveling state longitudinal slope and the map longitudinal slope; and
calculates a lateral slope for control, based on the traveling state lateral slope and the map lateral slope, and
wherein the vehicle control amount calculator calculates the target value of vehicle control amount of the ego vehicle, based on the traveling state, the longitudinal slope for control, and the lateral slope for control.

3. The vehicle control apparatus according to claim 2,
wherein the slope calculator determines whether or not the accuracy of the map longitudinal slope in the front of the ego vehicle is low, based on one or both of an absolute value and a change amount of the map longitudinal slope in the front of the ego vehicle;
determines whether or not the accuracy of the map lateral slope in the front of the ego vehicle is low, based on one or both of an absolute value and a change amount of the map lateral slope in the front of the ego vehicle;
does not use the map longitudinal slope in the front of the ego vehicle in calculation of the longitudinal slope for control, when determining that the accuracy of the map longitudinal slope in the front of the ego vehicle is low; and
does not use the map lateral slope in the front of the ego vehicle in calculation of the lateral slope for control, when determining that the accuracy of the map lateral slope in the front of the ego vehicle is low.

4. The vehicle control apparatus according to claim 2,
wherein the slope calculator calculates a curvature lateral slope estimation value which is a lateral slope in the front of the ego vehicle, based on a curvature of the road in the front of the ego vehicle and a regulation speed of the road in the front of the ego vehicle which are included in the map information;
determines whether or not the accuracy of the map lateral slope in the front of the ego vehicle is low, based on the map lateral slope in the front of the ego vehicle, and the curvature lateral slope estimation value in the front of the ego vehicle; and
does not use the map lateral slope in the front of the ego vehicle in calculation of the lateral slope for control when determining that the accuracy of the map lateral slope in the front of the ego vehicle is low.

5. The vehicle control apparatus according to claim 2,
wherein the slope calculator calculates an altitude longitudinal slope estimation value which is a longitudinal slope in the front of the ego vehicle, based on an altitude of the road in the front of the ego vehicle included in the map information;
determines whether or not the accuracy of the map longitudinal slope in the front of the ego vehicle is low, based on the map longitudinal slope in the front of the ego vehicle, and the altitude longitudinal slope estimation value in the front of the ego vehicle; and
does not use the map longitudinal slope in the front of the ego vehicle in calculation of the longitudinal slope for control when determining that the accuracy of the map longitudinal slope in the front of the ego vehicle is low.

6. The vehicle control apparatus according to claim 2,
wherein, when determining that the accuracy of the map longitudinal slope in the front of the ego vehicle is lower than a first state for longitudinal and is higher than a second state for longitudinal whose accuracy is lower that of the first state for longitudinal, the slope calculator determines that the accuracy of the map longitudinal slope in the front of the ego vehicle is low;
when determining that the accuracy of the map longitudinal slope in the front of the ego vehicle is lower than the second state for longitudinal, the slope calculator determines that both of the accuracy of the map longitudinal slope in the front of the ego vehicle and the accuracy of the map lateral slope in the front of the ego vehicle are low;
when determining that the accuracy of the map lateral slope in the front of the ego vehicle is lower than a first state for lateral and is higher than a second state for lateral whose accuracy is lower than that of the first state for lateral, the slope calculator determines that the accuracy of the map lateral slope in the front of the ego vehicle is low;
when determining that the accuracy of the map lateral slope in the front of the ego vehicle is lower than the second state for lateral, the slope calculator determines that both of the accuracy of the map longitudinal slope in the front of the ego vehicle and the accuracy of the map lateral slope in the front of the ego vehicle are low;
when determining that the accuracy of the map longitudinal slope in the front of the ego vehicle is low, the slope calculator does not use the map longitudinal slope in the front of the ego vehicle in calculation of the longitudinal slope for control; and
when determining that the accuracy of the map lateral slope in the front of the ego vehicle is low, the slope calculator does not use the map lateral slope in the front of the ego vehicle in calculation of the lateral slope for control.

7. The vehicle control apparatus according to claim 2,
wherein the slope calculator calculates a longitudinal slope difference which is a difference between the traveling state longitudinal slope and the map longitudinal slope at the ego vehicle position;
determines that whether or not the accuracy of the map longitudinal slope at the ego vehicle position is low, based on the longitudinal slope difference;
calculates a lateral slope difference which is a difference between the traveling state lateral slope and the map lateral slope at the ego vehicle position;
determines whether or not the accuracy of the map lateral slope at the ego vehicle position is low, based on the lateral slope difference;
does not use the map longitudinal slope at the ego vehicle position in calculation of the longitudinal slope for control, when determining that the accuracy of the map longitudinal slope at the ego vehicle position is low; and
does not use the map lateral slope at the ego vehicle position in calculation of the lateral slope for control, when determining that the accuracy of the map lateral slope at the ego vehicle position is low.

8. The vehicle control apparatus according to claim 2,
wherein the slope calculator calculates a map composite slope in the front of the ego vehicle which is obtained by combining the map longitudinal slope in the front of the ego vehicle and the map lateral slope in the front of the ego vehicle; and
determines whether or not the accuracy of the map slope in the front of the ego vehicle is low, based on the map composite slope in the front of the ego vehicle.

9. The vehicle control apparatus according to claim 1,
wherein the slope calculator changes a threshold value which is used when determining whether or not the accuracy of the map slope is low, according to a road type.

10. The vehicle control apparatus according to claim 1,
wherein the slope calculator changes a threshold value which is used when determining whether or not the accuracy of the map slope is low, according to a regulation speed of road.

11. The vehicle control apparatus according to claim 1,
wherein the slope calculator determines whether or not the accuracy of the map slope in the front of the ego vehicle is low;
determines whether or not the accuracy of the map slope at the ego vehicle position is low; and
makes a switching time until switching so as not to use the map slope in calculation of the slope for control after determining that the accuracy of the map slope in the front of the ego vehicle becomes low shorter than a switching time until switching so as not to use the map slope in calculation of the slope for control after determining that the accuracy of the map slope at the ego vehicle position becomes low.

12. A vehicle control method comprising:
acquiring a traveling state of an ego vehicle;
acquiring map information of a road where the ego vehicle is traveling;
estimating a traveling state slope which is a slope of the road at an ego vehicle position, based on the traveling state, calculating a map slope which is a slope of the road which includes a front of the ego vehicle, from the map information, and calculating a slope for control, based on the traveling state slope and the map slope; and
calculating a target value of vehicle control amount of the ego vehicle, based on the traveling state and the slope for the control,
wherein determining whether or not accuracy of the map slope is low, and not using the map slope in calculation of the slope for control when determining that the accuracy of the map slope is low.
